(19) United States
(12) Patent Application Publication
(10) Pub. No.: US 2014/0269409 A1
(43) Pub. Date: Sep. 18, 2014

(54) EXPLICIT SIGNALING OF NUMBER OF RECEIVER ANTENNAS

(71) Applicant: Telefonaktiebolaget L M Ericsson (publ), (US)

(72) Inventors: Konstantinos Dimou, Stockholm (SE); Franz Heiser, Jarfalla (SE)

(73) Assignee: TELEFONAKTIEBOLAGET L M ERICSSON (PUBL), Stockholm (SE)

(21) Appl. No.: 13/826,019

(22) Filed: Mar. 14, 2013

(51) Int. Cl. H04W 24/02

(52) U.S. Cl. CPC H04W 24/02
USPC 370/254

(57) ABSTRACT

Systems and methods for explicitly signaling a number of receiver antennas of one node in a cellular communications network to another node in the cellular communications network are disclosed. In one embodiment, a first node in the cellular communications network sends a number of receiver antennas of the first node to a second node in the cellular communications network. In one embodiment, the first node broadcasts the number of receiver antennas of the first node. In another embodiment, the first node unicasts the number of receiver antennas of the first node to the second node. The second node then utilizes the number of receiver antennas of the first node to perform a desired action.

### FIELD OF THE DISCLOSURE

The present disclosure relates to a cellular communications network and more particularly relates to explicit signaling of a number of receiver antennas of one node in a cellular communications network to another node in the cellular communications network.

### BACKGROUND

Modern cellular communications networks, such as 3^{rd} Generation Partnership Project (3GPP) Long Term Evolution (LTE) cellular communications networks, utilize Multiple Input Multiple Output (MIMO) techniques to provide improved system performance and/or improved service provisioning (e.g., higher per-user data rates). These MIMO techniques include, for example, Spatial or Polarization Diversity, Beam-Forming, and Spatial Division Multiplexing (SDM). Currently, the 3GPP LTE standard defines nine different transmission schemes for the downlink, which are referred to as transmission modes for the downlink. These nine transmission modes are:
Transmission Mode 1: Single-antenna transmission.
Transmission Mode 2: Transmit diversity.
Transmission Mode 3: Open-loop codebook-based precoding in the case of more than one layer.
Transmission Mode 4: Closed-loop codebook-based precoding.
Transmission Mode 5: Multi-user MIMO version of Transmission Mode 4.
Transmission Mode 6: Special case of closed-loop codebook-based precoding limited to single-transmission.
Transmission Mode 7: Release-8 non-codebook-based precoding supporting only single-layer transmission.
Transmission Mode 8: Release-9 non-codebook-based precoding supporting up to two layers.
Transmission Mode 9: Release-10 non-codebook-based precoding supporting up to eight layers.
   Transmission Mode 1 is a single-antenna transmission mode whereas Transmission Modes 2 through 9 are multi-antenna transmission modes.

LTE supports both beam-forming and SDM using antenna precoding (i.e., codebook-based precoding and non-codebook-based precoding). Codebook-based precoding can either be closed-loop or open-loop. For closed-loop antenna precoding, the cellular communications network selects the precoding matrix based on feedback from the corresponding mobile terminal or User Equipment (UE). In contrast, for open-loop antenna precoding, the precoding matrix is selected in a predefined and deterministic way that is known to the corresponding mobile terminal. Non-codebook-based precoding utilizes precoded reference signals in the downlink. The precoded reference signals allow the mobile terminal to demodulate and recover the transmitted layers without explicit knowledge of the precoding applied at the base station. More specifically, channel estimation at the mobile terminal based on the precoded reference signals reflects the channel experienced by the layers including the precoding and, as such, can be used directly for coherent demodulation of the different layers. The number of layers is the number of symbol streams transmitted in the downlink and can range from one layer up to the number of antenna ports of the base station.

LTE also enables MIMO techniques in the uplink. In the case of PUSCH transmission, the MIMO techniques are based on antenna precoding. For LTE, the precoding matrix for the uplink is selected by the cellular communications network and provided to the mobile terminal as part of the scheduling grant. Further, in order to limit downlink signaling, the LTE standard defines a limited set of precoder matrices for each transmission rank. The transmission rank is equal to the number of layers transmitted in the uplink. The manner in which the precoding matrix is selected is problematic is some situations. As such, there is a need for improved MIMO techniques for LTE (and similar) cellular communications networks particularly for uplink MIMO techniques.

In addition to the need for improved MIMO techniques, modern cellular communications networks, such as LTE cellular communications networks, face challenges resulting from new types of communications such as Machine-to-Machine (M2M) and Device-to-Device (D2D) communications. M2M communications are communications in which both endpoints are machines. Typically, the type of traffic exchanged between peer machines in M2M communications is different than the type of traffic exchanged between human operated devices (e.g., mobile terminals or UEs). Moreover, peer machines may have different hardware capabilities than expensive mobile terminals. M2M communications can be either directly (i.e., D2D) or via the cellular communications network using the traditional device-base station communication pattern. Conversely, D2D communications are direct communications between devices (e.g., two peer machines or two mobile terminals). Discovery and setup of D2D communications may be assisted by the cellular communications network.

For both M2M and D2D communications, future versions of the 3GPP standard are not likely to include uplink power control in the form that is conventionally used in 3GPP LTE communications networks. More specifically, it is envisioned that a high number of low-cost wireless sensors will be positioned at fixed locations. As such, tight power control of the uplink power of these wireless sensors with power control commands transmitted very frequently from the cellular communications network to the wireless sensors may not be needed. Moreover, tight uplink power control for these wireless sensors might not be feasible because these wireless sensors will likely have long sleep modes. The lack of tight power control, and in particular the lack of frequent power control commands, creates new problems that need to be addressed.

Finally, a common problem in cellular communications networks is interference. M2M and D2D communications preferably use the same time and frequency resources as the cellular communications network and, as such, new interference scenarios are created. Thus, there is also a need to address these new interference scenarios.

### SUMMARY

Systems and methods for explicitly signaling a number of receiver antennas of one node in a cellular communications network to another node in the cellular communications network are disclosed. In one embodiment, a first node in the cellular communications network sends a number of receiver antennas of the first node to a second node in the cellular communications network. In one embodiment, the first node broadcasts the number of receiver antennas of the first node. In another embodiment, the first node unicasts the number of receiver antennas of the first node to the second node. The second node then utilizes the number of receiver antennas of the first node to perform a desired action. The desired action can be any desired action that benefits from knowledge of the number of receiver antennas of the first node. In one embodiment, the first node is a base station and the second node is a wireless device. In another embodiment, the first node is a first wireless device and the second node is a second wireless device. In yet another embodiment, the first node is a wireless device and the second node is a base station. In addition, in some embodiments, the first node sends a number of Spatial Division Multiplexing (SDM) layers of a receiver of the first node to the second node, and the second node utilizes the number of receiver antennas and the number of SDM layers of the receiver of the first node to perform the desired action.

In one embodiment, the first node is a base station in the cellular communications network and the second node is a wireless device in the cellular communications network. In one embodiment, the base station broadcasts the number of receiver antennas of the base station. In one particular embodiment, the cellular communications network is a 3^{rd} Generation Partnership Project (3GPP) Long Term Evolution (LTE) cellular communications network, and the base station broadcasts the number of receiver antennas of the base station in a downlink shared channel (DL-SCH) in one or more System Information Blocks (SIBs). In another embodiment, the base station unicasts the number of receiver antennas of the base station to the wireless device. In one particular embodiment, the cellular communications network is a 3GPP LTE cellular communications network, and the base station unicasts the number of receiver antennas of the base station to the wireless device using Radio Resource Control (RRC) signaling. Once the wireless device has obtained the number of receiver antennas of the base station, the wireless device utilizes the number of receiver antennas of the base station to perform a desired action. In one embodiment, the desired action is making a decision as to whether to perform a handover. In another embodiment, the desired action is determining one or more precoding matrices to use for uplink transmissions from the wireless device to the base station. In yet another embodiment, the desired action is determining whether to apply one or more Multiple Input Multiple Output (MIMO) techniques and/or configuring the one or more MIMO techniques for an uplink from the wireless device to the base station.

In another embodiment, the first node is a base station in the cellular communications network and the second node is a wireless device in the cellular communications network. Further, in addition to sending the number of receiver antennas of the base station to the wireless device, the base station also sends a number of receiver antennas of each of one or more additional base stations (e.g., one or more neighboring base stations) to the wireless device. In one embodiment, the base station broadcasts the number of receiver antennas of the base station and the number of receiver antennas of each of the one or more additional base stations. In one particular embodiment, the cellular communications network is a 3GPP LTE cellular communications network, and the base station broadcasts the number of receiver antennas of the base station and the number of receiver antennas of each of the one or more additional base stations in a DL-SCH in one or more SIBs. In another embodiment, the base station unicasts the number of receiver antennas of the base station and the number of receiver antennas of each of the one or more additional base stations to the wireless device. In one particular embodiment, the cellular communications network is a 3GPP LTE cellular communications network, and the base station unicasts the number of receiver antennas of the base station and the number of receiver antennas of each of the one or more additional base stations to the wireless device using RRC signaling. The wireless device utilizes the number of receiver antennas of the base station and the number of receiver antennas of each of the one or more additional base stations to perform a desired action. In one embodiment, the desired action is making a decision as to whether to perform a handover. In another embodiment, the desired action is determining one or more precoding matrices to use for uplink communications to the base station. In yet another embodiment, the desired action is determining whether to apply one or more MIMO techniques and/or configuring the one or more MIMO techniques for an uplink from the wireless device to the base station.

In another embodiment, the first node is a wireless device and the second node is a base station in the cellular communications network. In one embodiment, the wireless device unicasts a number of receiver antennas and/or a number of SDM layers of the wireless device to the base station. Once the base station has obtained the number of receiver antennas and/or the number of SDM layers of the wireless device, the base station utilizes the number of receiver antennas and/or the number of SDM layers of the wireless device to perform a desired action. In one embodiment, the desired action is making a decision as to whether to perform a handover. In another embodiment, the desired action is determining one or more precoding matrices to use for downlink transmissions from the base station to the wireless device. In yet another embodiment, the desired action is determining whether to apply one or more MIMO techniques and/or configuring the one or more MIMO techniques for a downlink from the base station to the wireless device.

In another embodiment, the first node is a first wireless device in the cellular communications network and the second node is a second wireless device in the cellular communications network. In one embodiment, the first wireless device broadcasts a number of receiver antennas and/or the number of SDM layers of the first wireless device to other wireless devices, including the second wireless device, within a coverage area of the first wireless device. In another embodiment, the first wireless device unicasts the number of receiver antennas and/or the number of SDM layers of the first wireless device to the second wireless device. The second wireless device utilizes the number of receiver antennas and/or the number of SDM layers of the first wireless device to perform a desired action. In one embodiment, the desired action is determining one or more precoding matrices to use for Device-to-Device (D2D) transmissions to the first wireless device. In another embodiment, the desired action is determining whether to apply MIMO techniques and/or configuring MIMO techniques for D2D transmissions to the first wireless device. In yet another embodiment, the desired action is selecting a desired wireless device for a D2D connection from a group of potential wireless devices for the D2D connection. The group of potential wireless devices for the D2D connection includes the first wireless device. In particular, in this embodiment, the second wireless device selects the desired wireless device based on the number of receiver antennas and/or the number of SDM layers of the first wireless device as well as the number of receiver antennas and/or the number of SDM layers for each of the other wireless devices in the group of potential wireless devices for the D2D connection.

In another embodiment, a base station in a cellular communications network obtains a number of receiver antennas and/or a number of SDM layers of a first wireless device and sends the number of receiver antennas and/or the number of SDM layers of the first wireless device to a second wireless device. In one embodiment, the base station broadcasts the number of receiver antennas and/or the number of SDM layers of the first wireless device. In one particular embodiment, the cellular communications network is a 3GPP LTE cellular communications network, and the base station broadcasts the number of receiver antennas and/or the number of SDM layers of the first wireless device in a DL-SCH in one or more SIBs. In another embodiment, the base station unicasts the number of receiver antennas and/or the number of SDM layers of the first wireless device to the second wireless device. In one particular embodiment, the cellular communications network is a 3GPP LTE cellular communications network, and the base station unicasts the number of receiver antennas and/or the number of SDM layers of the first wireless device to the second wireless device using RRC signaling. Once the second wireless device has obtained the number of receiver antennas and/or the number of SDM layers of the first wireless device, the second wireless device utilizes the number of receiver antennas and/or the number of SDM layers of the first wireless device to perform a desired action. In one embodiment, the desired action is determining one or more precoding matrices to use for D2D transmissions from the second wireless device to the first wireless device. In another embodiment, the desired action is determining whether to apply MIMO techniques and/or configuring MIMO techniques for D2D transmissions from the second wireless device to the first wireless device.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a cellular communications network according to one embodiment of the present disclosure;

FIG. 2 is a flow chart that illustrates the operation of a first node in the cellular communications network to receive and utilize a number of receiver antennas and/or a number of Spatial Division Multiplexing (SDM) layers of a second node of the cellular communications network according to one embodiment of the present disclosure;

FIG. 3 is a flow diagram that illustrates the operation of one of the base stations of the cellular communications network of FIG. 1 to broadcast the number of receiver antennas and, in some embodiments, the number of SDM layers of the base station and one of the wireless devices of the cellular communications network to then utilize the number of receiver antennas and, in some embodiments, the number of SDM layers of the base station according to one embodiment of the present disclosure;

FIG. 4 is a flow diagram that illustrates one mechanism by which the base station of FIG. 3 broadcasts the number of receiver antennas and, in some embodiments, the number of SDM layers of the base station according to one embodiment of the present disclosure;

FIG. 5 is a flow diagram that illustrates the operation of one of the base stations of the cellular communications network of FIG. 1 to broadcast the number of receiver antennas and, in some embodiments, the number of SDM layers of the base station as well as the number of receiver antennas and, in some embodiments, the number of SDM layers of one or more neighboring base stations where one of the wireless devices of the cellular communications network then utilizes the number of receiver antennas and, in some embodiments, the number of SDM layers of the base station and/or the one or more neighboring base stations according to one embodiment of the present disclosure;

FIG. 6 is a flow diagram that illustrates the operation of one of the base stations of the cellular communications network of FIG. 1 to unicast the number of receiver antennas and, in some embodiments, the number of SDM layers of the base station to one of the wireless devices of the cellular communications network where the wireless device then utilizes the number of receiver antennas and, in some embodiments, the number of SDM layers of the base station according to one embodiment of the present disclosure;

FIG. 7 is a flow diagram that illustrates one mechanism by which the base station of FIG. 6 unicasts the number of receiver antennas and, in some embodiments, the number of SDM layers of the base station to the wireless device using Radio Resource Control (RRC) signaling according to one embodiment of the present disclosure;

FIG. 8 is a flow diagram that illustrates one mechanism by which the base station of FIG. 6 unicasts the number of receiver antennas and, in some embodiments, the number of SDM layers of the base station to the wireless device using RRC signaling according to another embodiment of the present disclosure;

FIG. 9 is a flow diagram that illustrates one mechanism by which the base station of FIG. 6 unicasts the number of receiver antennas and, in some embodiments, the number of SDM layers of the base station to the wireless device using RRC signaling according to another embodiment of the present disclosure;

FIG. 10 is a flow diagram that illustrates one mechanism by which the base station of FIG. 6 unicasts the number of receiver antennas and, in some embodiments, the number of SDM layers of the base station to the wireless device using uplink resource allocations according to one embodiment of the present disclosure;

FIG. 11 is a flow diagram that illustrates the operation of one of the base stations of the cellular communications network of FIG. 1 to unicast the number of receiver antennas and, in some embodiments, the number of SDM layers of the base station as well as the number of receiver antennas and, in some embodiments, the number of SDM layers of one or more neighboring base stations to one of the wireless devices, where the wireless device then utilizes the number of receiver antennas and, in some embodiments, the number of SDM layers of the base station and/or the one or more neighboring base stations according to one embodiment of the present disclosure;

FIG. 12 is a flow chart that illustrates the operation of one of the wireless devices to utilize the number of receiver antennas and, in some embodiments, the number of SDM layers of a base station to make a handover decision according to one embodiment of the present disclosure;

FIG. 13 is a flow chart that illustrates the operation of one of the wireless devices to utilize the number of receiver antennas and, in some embodiments, the number of SDM layers of a base station to determine one or more precoding matrices used for uplink transmissions to the base station according to one embodiment of the present disclosure;

FIG. 14 is a flow chart that illustrates the operation of one of the wireless devices to utilize the number of receiver antennas and, in some embodiments, the number of SDM layers of a base station to determine whether to apply one or more Multiple Input Multiple Output (MIMO) techniques and/or to configure the one or more MIMO techniques according to one embodiment of the present disclosure;

FIG. 15 is a flow diagram of the operation of a first wireless device in the cellular communications network of FIG. 1 to broadcast a number of receiver antennas and/or a number of SDM layers of the first wireless device, where a second wireless device in the cellular communications network utilizes the number of receiver antennas and/or the number of SDM layers of the first wireless device according to one embodiment of the present disclosure;

FIG. 16 is a flow diagram of the operation of a base station in the cellular communications network of FIG. 1 to broadcast a number of receiver antennas and SDM layers of a first wireless device in the cellular communications network, where the second wireless device utilizes the number of receiver antennas and/or the number of SDM layers of the first wireless device according to one embodiment of the present disclosure;

FIG. 17 is a flow diagram of the operation of a first wireless device in the cellular communications network of FIG. 1 to unicast a number of receiver antennas and/or a number of SDM layers of the first wireless device to a second wireless device in the cellular communications network, where the second wireless device utilizes the number of receiver antennas and/or the number of SDM layers of the first wireless device according to one embodiment of the present disclosure;

FIG. 18 is a flow diagram of the operation of a base station in the cellular communications network of FIG. 1 to unicast a number of receiver antennas and/or a number of SDM layers of a first wireless device in the cellular communications network to a second wireless device in the cellular communications network, where the second wireless device utilizes the number of receiver antennas and/or the number of SDM layers of the first wireless device according to one embodiment of the present disclosure;

FIG. 19 is a flow chart that illustrates the operation of a wireless device to utilize the number of receiver antennas and/or the number of SDM layers of another device to determine one or more precoding matrices for Device-to-Device (D2D) transmissions from the wireless device to the other wireless device according to one embodiment of the present disclosure;

FIG. 20 is a flow chart that illustrates the operation of a wireless device to utilize the number of receiver antennas and/or the number of SDM layers of another device to determine whether to apply one or more MIMO techniques to D2D transmissions from the wireless device to the other wireless device and/or to configure the MIMO techniques for D2D transmissions from the wireless device to the other wireless device according to one embodiment of the present disclosure;

FIG. 21 is a flow diagram that illustrates the operation of a wireless device to unicast a number of receiver antennas and/or a number of SDM layers of the wireless device to a serving base station of the wireless device and the utilization of the number of receiver antennas and/or the number of SDM layers of the wireless device by the base station according to one embodiment of the present disclosure;

FIG. 22 is a block diagram of one of the wireless devices in the cellular communications network of FIG. 1 according to one embodiment of the present disclosure;

FIG. 23 is a more detailed block diagram of the wireless device of FIG. 22 according to one embodiment of the present disclosure; and

FIG. 24 is a block diagram of one of the base stations in the cellular communications network of FIG. 1 according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

FIG. 1 illustrates a cellular communications network 10 according to one embodiment of the present disclosure. In this particular embodiment, the cellular communications network 10 is a 3^{rd} Generation Partnership Project (3GPP) Long Term Evolution (LTE) cellular communications network. However, the present disclosure is not limited thereto. Specifically, the systems and methods disclosed herein may be utilized in any type of cellular communications network. The cellular communications network 10 includes a Radio Access Network (RAN) that includes base stations (BSs) 12-1 and 12-2, which for LTE are referred to as eNodeBs (eNBs). The base stations 12-1 and 12-2 serve wireless devices (WDs) 14-1 through 14-5 located in corresponding cells 16-1 and 16-2 of the cellular communications network 10. The base stations 12-1 and 12-2 are more generally referred to herein collectively as base stations 12 and individually as base station 12. Likewise, the cells 16-1 and 16-2 are more generally referred to herein collectively as cells 16 and individually as cell 16. Similarly, the wireless devices 14-1 through 14-5 are more generally referred to herein collectively as wireless devices 14 and individually as wireless device 14. Notably, while only two base stations 12 and five wireless devices 14 are illustrated in FIG. 1 for clarity and ease of discussion, it will be readily appreciated that the cellular communications network 10 includes numerous base stations 12 and numerous wireless devices 14. Further, while in this embodiment the base stations 12 are macro base stations (e.g., eNBs), one or both of the base stations 12-1 and 12-2 may alternatively be micro, or low power, base stations (e.g., femto or pico base stations).

The wireless devices 14 are any type of wireless devices that are operable in the cellular communications network 10. The wireless devices 14 may include mobile terminals (e.g., mobile phones) and/or static (i.e., stationary) wireless devices. Still further, the wireless devices 14 may include user-operated wireless devices (e.g., mobile phones) and non-user-operated devices (e.g., machines or sensors). The wireless devices 14 can communicate with the cellular communications network 10 in the traditional manner. Still further, some or all of the wireless devices 14 may be operable to communicate directly with one another via Device-to-Device (D2D) communication links as illustrated for the wireless devices 14-2 and 14-3. In a similar manner, non-user-operated devices, or machines, may communicate via Machine-to-Machine (M2M) communications, which may flow through the cellular communications network 10 or D2D communications links.

The cellular communications network 10 also includes a core network 18, which includes a Serving Gateway (S-GW) 20 and a Mobility Management Entity (MME) 22. While only one S-GW 20 and one MME 22 are illustrated in this example, the core network 18 typically includes multiple S-GWs 20 and multiple MMEs 22. In LTE, the base stations 12 are connected to the S-GW 20 via corresponding S1-u connections and connected to the MME 22 via corresponding S1-c connections. Similarly, the base stations 12 are connected to other base stations 12 via X2 connections. For instance, the base stations 12-1 and 12-2 may be connected via an X2 connection. The S-GW 20 is a user plane node connecting the core network 18 to the RAN. Among other things, the S-GW 20 serves as a mobility anchor when the wireless devices 14 move between the cells 16 served by the base stations 12 as well as mobility anchors for other 3GPP technologies (e.g., Global System for Mobile Communications (GSM)/General Packet Radio Service (GPRS) and High Speed Packet Access (HSPA)). The MME 22 is a control plane node of the core network 18. The responsibilities of the MME 22 include connection/release of bearers to the wireless devices 14, handling of idle to active transitions, and handling of security keys.

Systems and methods are described herein for explicitly signaling a number of receiver antennas and, in some embodiments, a number of Spatial Division Multiplexing (SDM) layers of a receiver of one node in the cellular communications network 10 to another node in the cellular communications network 10. The number of receiver antennas and/or SDM layers are then used by the other node to perform a desired action. In this regard, FIG. 2 is a flow chart that illustrates a process for obtaining and using a number of receiver antennas and/or SDM layers of a receiver of another node in the cellular communications network 10 according to one embodiment of the present disclosure. First, a first node in the cellular communications network 10 obtains a number of receiver antennas and/or a number of SDM layers of a receiver of a second node in the cellular communications network 10 (step 100). To be clear, as used herein, the “number of receiver antennas” of the receiver of the second node is information that explicitly indicates the number of receiver antennas of the receiver of the second node. Likewise, the “number of SDM layers” of the receiver of the second node is information that explicitly indicates the number of SDM layers of the receiver of the second node. As discussed below in detail, in one embodiment, the first node is one of the wireless devices 14 and the second node is one of the base stations 12, where the wireless device 14 obtains the number of receiver antennas and, in some embodiments, the number of SDM layers of the receiver of the base station 12. In another embodiment, the first node is one of the base stations 12 and the second node is one of the wireless devices 14, where the base station 12 obtains the number of receiver antennas and/or the number of SDM layers of the receiver of the wireless device 14. In yet another embodiment, the first node is a first wireless device 14 and the second node is a second wireless device 14, where the first wireless device 14 obtains the number of receiver antennas and/or the number of SDM layers of the receiver of the second wireless device 14.

The first node then utilizes the number of receiver antennas and/or the number of SDM layers of the receiver of the second node to perform a desired action (step 102). In general, the desired action is any desired action that benefits from knowledge of the number of receiver antennas and/or the number of SDM layers of the second node. For example, in one embodiment, the first node is one of the wireless devices 14 and the second node is one of the base stations 12, and the desired action is making a handover decision based on the number of receiver antennas and/or the number of SDM layers of the base station 12. As another example, the desired action is determining a precoding matrix for a transmission from the first node to the second node. As yet another example, the desired action is determining whether to apply one or more Multiple Input Multiple Output (MIMO) techniques (e.g., diversity, beam forming, and/or spatial division multiplexing) to a transmission(s) from the first node to the second node and/or configuring the one or more MIMO techniques for the transmission(s) from the first node to the second node. As yet another example, in the case of one of the wireless devices 14 and a distributed antenna or shared cell configuration, the desired action may be deciding, by the wireless device 14, which radio access point to be used for a particular uplink transmission.

FIG. 3 is a flow diagram that illustrates explicit signaling of the number of receiver antennas and, in some embodiments, the number of SDM layers of one of the base stations 12 to one of the wireless devices 14 according to one embodiment of the present disclosure. First, the base station 12 obtains the number of receiver (RX) antennas and, in some embodiments, the number of SDM layers of the receiver of the base station 12 (step 200). In one embodiment, the number of receiver antennas and the number of SDM layers of the receiver of the base station 12 are stored in memory. In this case, the base station 12 may obtain the number of receiver antennas and, in some embodiments, the number of SDM layers from memory. In another embodiment, the base station 12 may perform a self-analysis process by which the base station 12 determines the number of receiver antennas and, in some embodiments, the number of SDM layers of the receiver of the base station 12. Next, the base station 12 broadcasts the number of receiver antennas and, in some embodiments, the number of SDM layers of the receiver of the base station 12 (step 202).

Upon receiving the broadcast, the wireless device 14 utilizes the number of receiver antennas and, in some embodiments, the number of SDM layers of the receiver of the base station 12 to perform a desired action (step 204). In one embodiment, the desired action is making a handover decision. A more detailed discussion of a handover decision based on the number of receiver antennas and, in some embodiments, the number of SDM layers of the receiver of the base station 12 is provided below with respect to FIG. 12. In another embodiment, the desired action performed by the wireless device 14 is determining a precoding matrix for an uplink transmission(s) to the base station 12 based on the number of receiver antennas and, in some embodiments, the number of SDM layers of the receiver of the base station 12. A more detailed discussion of determining the precoding matrix based on the number of receiver antennas and, in some embodiments, the number of SDM layers of the receiver of the base station 12 is provided below with respect to FIG. 13.

In yet another embodiment, the desired action performed by the wireless device 14 is determining whether to apply one or more MIMO techniques (e.g., diversity, beam forming, and/or spatial division multiplexing) for an uplink transmission(s) from the wireless device 14 to the base station 12 and/or configuring the one or more MIMO techniques for the uplink transmission(s) from the wireless device 14 to the base station 12. A more detailed discussion of determining whether to apply and/or configuring one or more MIMO techniques based on the number of receiver antennas and, in some embodiments, the number of SDM layers of the receiver of the base station 12 is provided below with respect to FIG. 14. In yet another embodiment, in the case of one of the wireless devices 14 and a distributed antenna or shared cell configuration, the desired action may be deciding, by the wireless device 14, which radio access point to be used for a particular uplink transmission. Note that these examples of the desired action are examples only and are not intended to limit the scope of the present disclosure.

FIG. 4 is a flow diagram that illustrates explicit signaling of the number of receiver antennas and, in some embodiments, the number of SDM layers of one of the base stations 12 to one of the wireless devices 14 via a broadcast technique according to one embodiment of the present disclosure. More specifically, the process of FIG. 4 is one particular implementation for the process of FIG. 3 where the cellular communications network 10 is a 3GPP LTE cellular communications network. In this process, the base station 12 obtains the number of receiver antennas and, in some embodiments, the number of SDM layers of the receiver of the base station 12 as discussed above (step 300). It should be noted that while step 300 is illustrated as a first step of the process of FIG. 4, the process is not limited thereto. Step 300 may be performed at any point prior to the broadcast in step 306.

In this embodiment, the wireless device 14 is operating in an idle mode. While the wireless device 14 is in the idle mode, the base station 12 broadcasts synchronization signals (step 302). Using the synchronization signals, the wireless device 14 operates to perform a cell search process by which the wireless device 14 synchronizes to the base station 12 (step 304). The base station 12 broadcasts cell System Information including the number of receiver antennas and, in some embodiments, the number of SDM layers of the receiver of the base station 12 (step 306). In particular, in this embodiment, the number of receiver antennas and, in some embodiments, the number of SDM layers are included as one or more Information Elements (IEs) which can be appended to an existing System Information Block (SIB) or included in a new SIB, which could be defined in 3GPP Technical Specification (TS) 36.331 for “LTE; Evolved Universal Terrestrial Access (E-UTRA); Radio Resource Control (RRC); Protocol specification.” Once the wireless device 14 is synchronized to the base station 12 as a result of the cell search process of step 304, the wireless device 14 receives and decodes the broadcast of the cell System Information including the number of receiver antennas and, in some embodiments, the number of SDM layers of the receiver of the base station 12 (step 308). The wireless device 14 then utilizes the number of receiver antennas and, in some embodiments, the number of SDM layers of the receiver of the base station 12 to perform a desired action (step 310). As discussed above, the desired action may be, for example, making a handover decision, determining a precoding matrix for an uplink transmission(s) from the wireless device 14 to the base station 12 or to another device in the context of direct D2D communication, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIG. 5 is a flow diagram that illustrates explicit signaling of the number of receiver antennas and, in some embodiments, the number of SDM layers of one of the base stations 12 as well as the number of receiver antennas and, in some embodiments, the number of SDM layers of one or more additional base stations 12 to one of the wireless devices 14 according to one embodiment of the present disclosure. This embodiment is similar to that of FIGS. 3 and 4 but where the base station 12 additionally signals the number of receiver antennas and, in some embodiments, the number of receiver antennas of each of one or more additional base stations 12. In this example, the one or more additional base stations 12 are one or more neighboring base stations 12 of the base station 12.

More specifically, the base station 12 obtains the number of receiver antennas and, in some embodiments, the number of SDM layers of the receiver of the base station 12 as discussed above (step 400). In addition, for each of one or more neighboring base stations 12 of the base station 12, the base station 12 receives the number of receiver antennas and, in some embodiments, the number of SDM layers of the receiver of the neighboring base station 12 (step 402). In one embodiment, the cellular communications network 10 is a 3GPP LTE cellular communications network, and the base station 12 receives the number of receiver antennas and, in some embodiments, the number of SDM layers of the receiver of the neighboring base station 12 via an X2 or S1 interface between the base stations 12. For example, the number of receiver antennas and, in some embodiments, the number of SDM layers of the receiver of the neighboring base station 12 may be included in one or more IEs appended in an X2 setup request or response message. Currently, the X2 setup request and response messages include Served Cell Information. The Served Cell Information includes a number of transmitter antenna ports of the corresponding base station 12. Here, in one embodiment, the number of receiver antennas and, in some embodiments, the number of SDM layers of the receiver of the neighboring base station 12 may be added to the Served Cell Information. In a similar manner, the number of receiver antennas and, in some embodiments, the number of SDM layers of the neighboring base station 12 may be communicated via the S1 interface.

The base station 12 broadcasts the number of receiver antennas and, in some embodiments, the number of SDM layers of the receiver of the base station 12 as well as the number of receiver antennas and, in some embodiments, the number of SDM layers of the receiver of each of the neighboring base stations 12 (step 404). As discussed above with respect to FIG. 4, in one particular embodiment, the cellular communications network 10 is a 3GPP LTE cellular communications network, and the number of receiver antennas and, in some embodiments, the number of SDM layers of the receiver of the base station 12 are broadcast as one or more IEs in one or more SIBs in the cell System Information broadcast by the base station 12 on the shared downlink channel of the base station 12. Likewise, for each of the one or more neighboring base stations 12, the number of receiver antennas and, in some embodiments, the number of SDM layers of the receiver of the neighboring base station 12 are broadcast as one or more IEs in one or more SIBs in the cell System Information broadcast by the base station 12 on the shared downlink channel of the base station 12.

After receiving the broadcast, the wireless device 14 utilizes the number of receiver antennas and, in some embodiments, the number of SDM layers of the receiver of the base station 12 and the one or more neighboring base stations 12 to perform a desired action (step 406). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration. Notably, while in the embodiment the wireless device 14 utilizes the number of receiver antennas and, in some embodiments, the number of SDM layers of the base station 12 and the one or more neighboring base stations 12 to perform the desired action, the base station 12 may additionally or alternatively use the number of receiver antennas and/or the number of SDM layers of the neighboring base stations 12 to perform a desired action. For example, the base station 12 may select or otherwise determine a precoding matrix for the wireless device 14 that: (1) provides beam-forming in the direction of the base station 12 and (2) provides nulls in the direction(s) of the neighboring base station(s) 12.

While FIGS. 3-5 illustrate embodiments that use a broadcast mechanism to explicitly signal information from the base station 12 to the wireless device 14, FIGS. 6-11 illustrate embodiments that use a unicast mechanism to explicitly signal information from the base station 12 to the wireless device 14. More specifically, FIG. 6 is a flow diagram that illustrates explicit signaling of the number of receiver antennas and, in some embodiments, the number of SDM layers of one of the base stations 12 to one of the wireless devices 14 using a unicast mechanism according to one embodiment of the present disclosure. In this embodiment, the base station 12 obtains the number of receiver antennas and, in some embodiments, the number of SDM layers of the receiver of the base station 12 as discussed above (step 500). At some point, the wireless device 14 sends a request to the base station 12 for the number of receiver antennas and, in some embodiments, the number of SDM layers of the receiver of the base station 12 (step 502). Note, however, that the request of step 502 is optional. Specifically, in some embodiments, there may be no request. It should also be noted that while step 500 is illustrated as occurring before step 502 in FIG. 6, the present disclosure is not limited thereto.

Next, the base station 12 unicasts the number of receiver antennas and, in some embodiments, the number of SDM layers of the receiver of the base station 12 to the wireless device 14 (step 504). Any suitable unicast mechanism may be used. For instance, in one embodiment, the cellular communications network 10 is a 3GPP LTE cellular communications network, and the base station 12 unicasts the number of receiver antennas and, in some embodiments, the number of SDM layers of the receiver of the base station 12 using Radio Resource Control (RRC) signaling. In another embodiment, the cellular communications network 10 is a 3GPP LTE cellular communications network, and the base station 12 unicasts the number of receiver antennas and, in some embodiments, the number of SDM layers of the receiver of the base station 12 via uplink allocations to the wireless device 14 in a downlink physical downlink control channel (DL-PDCCH). However, other unicast mechanisms may be used.

Lastly, the wireless device 14 utilizes the number of receiver antennas and, in some embodiments, the number of SDM layers of the receiver of the base station 12 to perform a desired action (step 506). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIG. 7 is a flow diagram that illustrates one RRC signaling mechanism that can be utilized by the base station 12 to unicast the number of receiver antennas and, in some embodiments, the number of SDM layers of the receiver of the base station 12 to the wireless device 14 according to one embodiment of the present disclosure. In this embodiment, the cellular communications network 10 is a 3GPP LTE cellular communications network and, as such, some 3GPP LTE terminology is used. However, similar signaling may be used as a unicast mechanism in other types of cellular communications networks. In this embodiment, the base station 12 obtains the number of receiver antennas and, in some embodiments, the number of SDM layers of the receiver of the base station 12 as discussed above (step 600). Note that step 600 may alternatively be performed later in the process (e.g., between steps 610 and 612).

At some point, the wireless device 14 performs a cell search process to thereby synchronize to the base station 12 (step 602). When the wireless device 14 desires to transition from the idle state to a connected state, the wireless device 14 performs a random access procedure. More specifically, the wireless device 14 sends a random access preamble to the base station 12, receives a random access response from the base station 12, and adjusts an uplink timing of the wireless device 14 in the conventional manner (steps 604-608). The wireless device 14 then utilizes RRC signaling to send a request to the base station 12 for the number of receiver antennas and, in some embodiments, the number of SDM layers of the receiver of the base station 12 (step 610). More specifically, as part of the RRC signaling of step 610, the wireless device 14 sends an RRC connection request to the base station 12 in order to request a connection to the base station 12. In one embodiment, the request for the number of receiver antennas and, in some embodiments, the number of SDM layers of the receiver of the base station 12 is appended to the RRC connection request (e.g., as one or more IEs). Note, however, that the request of step 610 is optional.

Next, the base station 12 sends the number of receiver antennas and, in some embodiments, the number of SDM layers of the receiver of the base station 12 to the wireless device 14 via RRC signaling (step 612). More specifically, as part of the RRC signaling of step 612, the base station 12 sends an RRC connection confirm message to the wireless device 14. In one embodiment, the base station 12 appends the number of receiver antennas and, in some embodiments, the number of SDM layers of the receiver of the base station 12 to the RRC connection confirm message (e.g., as one or more IEs).

Lastly, the wireless device 14 utilizes the number of receiver antennas and, in some embodiments, the number of SDM layers of the receiver of the base station 12 to perform a desired action (step 614). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIG. 8 is a flow diagram that illustrates another RRC signaling mechanism that can be utilized by the base station 12 to unicast the number of receiver antennas and, in some embodiments, the number of SDM layers of the receiver of the base station 12 to the wireless device 14 according to one embodiment of the present disclosure. In this embodiment, the cellular communications network 10 is a 3GPP LTE cellular communications network and, as such, some 3GPP LTE terminology is used. However, similar signaling may be used as a unicast mechanism in other types of cellular communications networks. In this embodiment, the base station 12 obtains the number of receiver antennas and, in some embodiments, the number of SDM layers of the receiver of the base station 12 as discussed above (step 700). Note that step 700 may alternatively be performed later in the process (e.g., between steps 702 and 704).

At some point while the wireless device 14 is in the connected state, the base station 12 sends an RRC connection reconfiguration message to the wireless device 14 that includes the number of receiver antennas and, in some embodiments, the number of SDM layers of the receiver of the base station 12 (step 702). The RRC connection reconfiguration message may be sent, for example, upon establishment of a radio bearer between the wireless device 14 and the base station 12. While not necessary for understanding the concepts disclosed herein, for more information regarding the RRC connection reconfiguration message, the interested reader is directed to 3GPP TS 36.331, version 11.1.0. In step 702, the RRC connection reconfiguration message is utilized to unicast the number of receiver antennas and, in some embodiments, the number of SDM layers of the receiver of the base station 12 to the wireless device 14. In response to the RRC connection reconfiguration message, the wireless device 14 sends an RRC connection reconfiguration complete message to the base station 12 (step 704).

Lastly, the wireless device 14 utilizes the number of receiver antennas and, in some embodiments, the number of SDM layers of the receiver of the base station 12 to perform a desired action (step 706). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIG. 9 is a flow diagram that illustrates another RRC signaling mechanism that can be utilized by the base station 12 to unicast the number of receiver antennas and, in some embodiments, the number of SDM layers of the receiver of the base station 12 to the wireless device 14 according to one embodiment of the present disclosure. In this embodiment, the cellular communications network 10 is a 3GPP LTE cellular communications network and, as such, some 3GPP LTE terminology is used. However, similar signaling may be used as a unicast mechanism in other types of cellular communications networks. In this embodiment, the base station 12 obtains the number of receiver antennas and, in some embodiments, the number of SDM layers of the receiver of the base station 12 as discussed above (step 800). Note that step 800 may alternatively be performed later in the process (e.g., between steps 802 and 804).

At some point while the wireless device 14 is in the connected state, the wireless device 14 sends an RRC network node information request to the base station 12 (step 802). The RRC network node information request is a new type of RRC message that is not currently specified in the 3GPP LTE specifications. In response, the base station 12 sends an RRC network node information message to the wireless device 14, where the RRC network node information message includes the number of receiver antennas and, in some embodiments, the number of SDM layers of the receiver of the base station 12 (step 804). The wireless device 14 then utilizes the number of receiver antennas and, in some embodiments, the number of SDM layers of the receiver of the base station 12 to perform a desired action (step 806). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIG. 10 is a flow diagram that illustrates explicit signaling of the number of receiver antennas and, in some embodiments, the number of SDM layers of one of the base stations 12 to one of the wireless devices 14 using a unicast mechanism according to another embodiment of the present disclosure. In this embodiment, the base station 12 obtains the number of receiver antennas and, in some embodiments, the number of SDM layers of the receiver of the base station 12 as discussed above (step 900). At some point, the base station 12 sends uplink (UL) allocation(s) to the wireless device 14 including the number of receiver antennas and, in some embodiments, the number of SDM layers of the receiver of the base station 12 (step 902). In one particular embodiment, the cellular communications network 10 is a 3GPP LTE cellular communications network, and the uplink allocation(s) is sent to the wireless device 14 in the DL-PDCCH.

Lastly, the wireless device 14 utilizes the number of receiver antennas and, in some embodiments, the number of SDM layers of the receiver of the base station 12 to perform a desired action (step 904). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIG. 11 is a flow diagram that illustrates explicit signaling of the number of receiver antennas and, in some embodiments, the number of SDM layers of one of the base stations 12 as well as the number of receiver antennas and, in some embodiments, the number of SDM layers of one or more additional base stations 12 to one of the wireless devices 14 using a unicast mechanism according to one embodiment of the present disclosure. This embodiment is similar to that of FIG. 6 but where the base station 12 additionally signals the number of receiver antennas and, in some embodiments, the number of SDM layers of each of one or more additional base stations 12. In this embodiment, the one or more additional base stations 12 are one or more neighboring base stations 12 of the base station 12. More specifically, the base station 12 obtains the number of receiver antennas and, in some embodiments, the number of SDM layers of the receiver of the base station 12 as discussed above (step 1000). In addition, for each of one or more neighboring base stations 12 of the base station 12, the base station 12 receives the number of receiver antennas and, in some embodiments, the number of SDM layers of the receiver of the neighboring base station 12 (step 1002). As discussed above, in one embodiment, the number of receiver antennas and, in some embodiments, the number of SDM layers of the receiver of the neighboring base station 12 may be communicated to the base station 12 via the X2 or S1 interface between the base stations 12.

Optionally, the wireless device 14 sends a request to the base station 12 for the number of receiver antennas and, in some embodiments, the number of SDM layers of the receiver of the base station 12 as well as the number of receiver antennas and, in some embodiments, the number of SDM layers of the receiver of each of the one or more neighboring base stations 12 (step 1004). Notably, the one or more neighboring base stations 12 may be all of the neighboring base stations 12 of the base station 12 or some subset thereof. The base station 12 then unicasts the number of receiver antennas and, in some embodiments, the number of SDM layers of the receiver of the base station 12 as well as the number of receiver antennas and, in some embodiments, the number of SDM layers of the receiver of each of the neighboring base station 12 to the wireless device 14 (step 1006). As discussed above with respect to FIGS. 6-10, the cellular communications network 10 is a 3GPP LTE cellular communications network, and the number of receiver antennas and, in some embodiments, the number of SDM layers of the receiver of the base station 12 may be unicast to the wireless device 14 using RRC signaling or uplink allocation(s) of the wireless device 14. Likewise, for each of the one or more neighboring base stations 12, the number of receiver antennas and, in some embodiments, the number of SDM layers of the receiver of the neighboring base station 12 may be unicast to the wireless device 14 using RRC signaling or uplink allocation(s) of the wireless device 14.

After receiving the unicast, the wireless device 14 utilizes the number of receiver antennas and, in some embodiments, the number of SDM layers of the receiver of the base station 12 and the one or more neighboring base stations 12 to perform a desired task (step 1008). As discussed above, the desired action may be, for example, making a handover decision, determining a precoding matrix for an uplink transmission(s) from the wireless device 14 to the base station 12, determining whether to apply one or more MIMO techniques for an uplink transmission(s) from the wireless device 14 to the base station 12, configuring one or more MIMO techniques for an uplink transmission(s) from the wireless device 14 to the base station 12, or selecting an access point for a particular uplink transmission in a distributed antenna or shared cell network configuration.

FIGS. 12-14 are flow charts that illustrate some examples of the operation of the wireless device 14 to perform a desired action based on the number of receiver antennas and, in some embodiments, the number of SDM layers of the receiver of the base station 12 and, in some embodiments, the receiver(s) of one or more additional (e.g., neighboring) base stations 12. The processes of FIGS. 12-14 are examples only and are not intended to limit the scope of the present disclosure. Other desired actions may be performed. In this regard, FIG. 12 illustrates a process for making a handover decision according to one embodiment of the present disclosure. In general, the handover decision is a decision as to whether to perform a handover of the wireless device 14 from a serving base station 12 of the wireless device 14 to a potential target base station 12. It should be noted that the methods described herein for making handover decisions may also be utilized to perform cell selection when the wireless device 14 is in the idle state.

First, the wireless device 14 makes a handover decision based on the number of receiver antennas and, in some embodiments, the number of SDM layers of the receiver of the serving base station 12 and the number of receiver antennas and, in some embodiments, the number of SDM layers of the potential target base station 12 (step 1100). Notably, as discussed above, the wireless device 14 obtains the number of receiver antennas and, in some embodiments, the number of SDM layers of the receiver of the serving base station 12 of the wireless device 14 as well as a potential target base station 12 for the handover process prior to making the handover decision. In one embodiment, the wireless device 14 receives the number of receiver antennas and, in some embodiments, the number of SDM layers of the receiver of the serving base station 12 via a broadcast or unicast from the serving base station 12 and receives the number of receiver antennas and, in some embodiments, the number of SDM layers of the potential target base station 12 via a separate broadcast or unicast from the potential target base station 12. In another embodiment, the wireless device 14 receives the number of receiver antennas and, in some embodiments, the number of SDM layers of the receiver of the serving base station 12 and the number of receiver antennas and, in some embodiments, the number of SDM layers of the receiver of the potential target base station 12 via a broadcast or unicast from either the serving base station 12 or the potential target base station 12. The wireless device 14 then determines whether the handover decision was positive (i.e., yes) or negative (i.e., no) (step 1102). If the handover decision is negative, the process ends. Conversely, if the handover decision is positive, the wireless device 14 performs a handover from the serving base station 12 to the potential target base station 12 using a conventional handover process (step 1104).

More specifically, in one embodiment, the wireless device 14 determines that a handover to the potential target base station 12 is to be performed if the number of receiver antennas of the potential target base station 12 exceeds a predefined threshold and any other predefined criteria are satisfied. The predefined threshold may be, for example, the number of receiver antennas of the serving base station 12 of the wireless device 14 or a number of receiver antennas of the serving base station 12 of the wireless device 14 plus a predefined offset. In this case, the wireless device 14 determines that the handover to the potential target base station 12 is to be performed if: (1) the number of receiver antennas of the potential target base station 12 is greater than the number of receiver antennas of the serving base station 12 or is greater than the number of receiver antennas of the serving base station 12 plus a predefined offset and (2) any other predefined criteria for performing a handover are satisfied. The one or more predefined criteria may include, for example, a criterion that a signal strength of the potential target base station 12 exceeds a predefined minimum threshold for at least a threshold amount of time. In a similar manner, the number of SDM layers of the receiver of the serving and/or potential target base station 12 may be considered for the handover decision in addition to the number of receiver antennas.

In one particular example, consider a scenario in which the wireless device 14 measures a Reference Signal Receive Power (RSRP) of −100 Decibel-milliwatt (dBm) for the serving base station 12 and a slightly lower (e.g., −101 dBm) RSRP for the potential target base station 12 and a handover threshold for signal strength is, for example, 1 Decibel (dB). Then, normally, a handover would not be performed. However, if, for instance, the wireless device 14 is handling mostly uplink traffic, then the uplink may be considered of higher importance than the downlink. As such, the wireless device 14 also considers the number of receiver antennas of the potential target base station 12 as compared to the number of receiver antennas of the serving base station 12. If, for example, the serving base station 12 has four receiver antennas and the potential target base station 12 has six receiver antennas, the wireless device 14 may then decide to perform a handover to the potential target base station 12 even though the RSRP of the potential target base station 12 is slightly lower than the RSRP of the serving base station 12.

FIG. 13 illustrates a process for determining and using a precoding matrix for uplink transmission(s) from the wireless device 14 to the serving base station 12 according to one embodiment of the present disclosure. First, the wireless device 14 determines one or more precoding matrices for one or more uplink transmissions from the wireless device 14 to the serving base station 12 based on the number of receiver antennas and, in some embodiments, the number of SDM layers of the receiver of the serving base station 12 (step 1200). Typically, a precoding matrix includes a number of rows that correspond to the number of receiver antennas of the receiver of the serving base station 12 and a number of columns that correspond to the number of transmitter antennas of a transmitter of the wireless device 14. Using the number of receiver antennas of the serving base station 12 and the number of transmitter antennas of the wireless device 14, the wireless device 14 can select or otherwise determine a precoding matrix of the appropriate size. The determination of the precoding matrix by the wireless device 14 may be desirable, for example, in certain situations where the wireless device 14 is unable to receive an allocated precoding matrix from the cellular communications network 10. This may occur, for instance, during a random access procedure or during radio link failure recovery. In these situations, the wireless device 14 may select or otherwise determine one or more precoding matrices for an uplink transmission(s) to the serving base station 12 based on the number of receiver antennas of the serving base station 12. Further, in some embodiments, the number of SDM layers of the receiver of the base station 12 may also be used to select or otherwise determine the one or more precoding matrices for the uplink transmission(s). Once the one or more precoding matrices are determined, the wireless device 14 precodes the one or more uplink transmissions using the corresponding one or more precoding matrices (step 1102) and transmits the precoded uplink transmission(s) to the serving base station 12 (step 1104).

FIG. 14 illustrates a process for determining whether to apply one or more MIMO techniques and configuring the one or more MIMO techniques according to one embodiment of the present disclosure. First, the wireless device 14 determines whether to apply one or more MIMO techniques to an uplink transmission(s) from the wireless device 14 to the base station 12 based on the number of receiver antennas and, in some embodiments, the number of SDM layers of the receiver of the base station 12 (step 1300). For example, the wireless device 14 may determine whether MIMO techniques for reducing interference caused by transmissions by the wireless device 14 to, for instance, neighboring base stations 12 or other wireless devices 14 are desired. If a determination is made to not apply the MIMO technique(s), the process proceeds to step 1304. If a determination is made to apply the MIMO technique(s), the wireless device 14 then configures the MIMO technique(s) (step 1302). In this embodiment, the MIMO technique(s) are configured based on the number of receiver antennas and, in some embodiments, the number of SDM layers of the receiver of the base station 12. Returning to the interference example, if MIMO techniques are desired to reduce interference caused by transmissions by the wireless device 14 to neighboring base stations 12, the wireless device 14 may configure one or more MIMO techniques to reduce interference to a closest neighboring base station 12. For instance, the wireless device 14 may use beam-forming to create a null in the direction of the closest neighboring base station 12. Lastly, whether proceeding from step 1300 or 1302, the wireless device 14 transmits uplink transmissions to the base station 12 (step 1304). If the MIMO technique(s) are to be applied and are configured, the uplink transmissions are transmitted using the MIMO technique(s). Otherwise, the uplink transmissions are transmitted without using the MIMO technique(s).

Before proceeding, it should be noted that FIGS. 12-14 are only some examples of desired actions that may be performed based on the number of receiver antennas and, in some embodiments, the number of SDM layers of the receiver of one or more of the base station 12. Other desired actions may additionally or alternatively be performed. For example, blind null space learning is a MIMO technique that requires that the number of transmitter antennas be higher than the number of receiver antennas. As such, the wireless device 14 may determine whether to apply blind null space learning based, at least in part, on the number of receiver antennas of the base station 12 as compared to the number of transmitter antennas of the base station 12 (which is known). The wireless device 14 may further use the number of receiver antennas to configure blind null space learning. As another example, in a distributed antenna system or shared cell configuration, the wireless device 14 may utilize the number of receiver antennas and, in some embodiments, the number of SDM layers of one or more base stations 12 to decide a radio access point to be used for a particular uplink transmission in a dynamic manner. As another example, the wireless device 14 may be connected to more than one base station 12 (i.e., a soft cell), and the wireless device 14 can select or otherwise determine a precoding matrix to be used for uplink transmission(s) based on the number of receiver antennas and, in some embodiments, the number of SDM layers of the base station 12 to which the wireless device 14 wants to connect. As yet another example, if a scenario where the wireless device 14 is a 3GPP wireless sensor, the number of receiver antennas and, in some embodiments, the number of SDM layers of the base station(s) 12 may be used to provide a coverage enhancement. More specifically, the wireless sensor may need to repeat its transmissions N times or need to extend its wireless transmissions and repeat them. The wireless sensor may use the number of receiver antennas of the base station 12 and, in some embodiments, the number of SDM layers of the base station 12 as well as a downlink received signal strength to determine an estimated number N of times the transmissions should be repeated.

The embodiments above all involve explicitly signaling the number of receiver antennas and, in some embodiments, the number of SDM layers of the base station 12 and, in some embodiments, one or more additional base stations 12 to the wireless device 14. FIGS. 15-18 illustrate embodiments where the number of receiver antennas and/or the number of SDM layers of a receiver of one of the wireless devices 14 is explicitly signaled to another one of the wireless devices 14. In this regard, FIG. 15 is a flow diagram that illustrates explicit signaling of the number of receiver antennas and/or the number of SDM layers of one of the wireless devices 14 to another one of the wireless devices 14 using a broadcast mechanism according to one embodiment of the present disclosure. In this embodiment, the wireless devices 14 are the wireless devices 14-2 and 14-3 of FIG. 1, where the wireless device 14-3 broadcasts the number of receiver antennas and/or the number of SDM layers of a receiver of the wireless device 14-3 and the wireless device 14-2 utilizes this information to perform a desired action with respect to D2D communication between the wireless devices 14-2 and 14-3.

More specifically, first, the wireless device 14-3 obtains the number of receiver antennas and/or the number of SDM layers of the receiver of the wireless device 14-3 (step 1400). In one embodiment, the number of receiver antennas and/or the number of SDM layers of the receiver of the wireless device 14-3 are stored in memory. In this case, the wireless device 14-3 may obtain the number of receiver antennas and/or the number of SDM layers from memory. In another embodiment, the wireless device 14-3 may perform a self-analysis process by which the wireless device 14-3 determines the number of receiver antennas and/or the number of SDM layers of the receiver of the wireless device 14-3. Next, the wireless device 14-3 broadcasts the number of receiver antennas and/or the number of SDM layers of the receiver of the wireless device 14-3 (step 1402). The wireless device 14-3 broadcasts the number of receiver antennas and/or the number of SDM layers to all of the other wireless devices 14 that are within a wireless coverage area of the wireless device 14-3.

Upon receiving the broadcast, the wireless device 14-2 utilizes the number of receiver antennas and/or the number of SDM layers of the receiver of the wireless device 14-3 to perform a desired action (step 1404). In one embodiment, the desired action performed by the wireless device 14-2 is determining a precoding matrix for a D2D transmission(s) to the wireless device 14-3 based on the number of receiver antennas and/or the number of SDM layers of the receiver of the wireless device 14-3, as discussed below in detail with respect to FIG. 19. In yet another embodiment, the desired action performed by the wireless device 14-2 is determining whether to apply one or more MIMO techniques (e.g., diversity, beam forming, and/or spatial division multiplexing) for a D2D transmission(s) from the wireless device 14-2 to the wireless device 14-3 and/or configuring the one or more MIMO techniques for the D2D transmission(s) from the wireless device 14-2 to the wireless device 14-3, as discussed below in detail with respect to FIG. 20. Note that these examples of the desired action are examples only and are not intended to limit the scope of the present disclosure.

FIG. 16 is a flow diagram that illustrates explicit signaling of the number of receiver antennas and/or the number of SDM layers of one of the wireless devices 14 to another one of the wireless devices 14 using a broadcast mechanism according to another embodiment of the present disclosure. This embodiment is referred to herein as a network-assisted embodiment. First, the wireless device 14-3 obtains the number of receiver antennas and/or the number of SDM layers of the receiver of the wireless device 14-3 as discussed above (step 1500). Next, the wireless device 14-3 sends the number of receiver antennas and/or the number of SDM layers of the receiver of the wireless device 14-3 to the base station 12-1 (step 1502). The wireless device 14-3 sends the number of receiver antennas and/or the number of SDM layers of the receiver of the wireless device 14-3 to the base station 12-1 using any suitable mechanism (e.g., RRC signaling).

The base station 12-1 then broadcasts the number of receiver antennas and/or the number of SDM layers of the receiver of the wireless device 14-3 (step 1504). The base station 12-1 broadcasts the number of receiver antennas and/or the number of SDM layers of the receiver of the wireless device 14-3 to all of the wireless devices 14 that are within a wireless coverage area of the base station 12-1. In one particular embodiment, the cellular communications network 10 is a 3GPP LTE cellular communications network, and the base station 12-1 broadcasts the number of receiver antennas and/or the number of SDM layers of the receiver of the wireless device 14-3 as one or more IEs in one or more SIBs in the shared downlink channel of the base station 12-1. Upon receiving the broadcast, the wireless device 14-2 utilizes the number of receiver antennas and/or the number of SDM layers of the receiver of the wireless device 14-3 to perform a desired action (step 1506). As discussed above, the desired action may be, for example, determining a precoding matrix for a D2D transmission(s) from the wireless device 14-2 to the wireless device 14-3, determining whether to apply one or more MIMO techniques for a D2D transmission(s) from the wireless device 14-2 to the wireless device 14-3, or configuring one or more MIMO techniques for a D2D transmission(s) from the wireless device 14-2 to the wireless device 14-3.

FIG. 17 is a flow diagram that illustrates explicit signaling of the number of receiver antennas and/or the number of SDM layers of one of the wireless devices 14 to another one of the wireless devices 14 using a unicast mechanism according to one embodiment of the present disclosure. In this embodiment, the wireless devices 14 are the wireless devices 14-2 and 14-3 of FIG. 1, where the wireless device 14-3 unicasts the number of receiver antennas and/or the number of SDM layers of a receiver of the wireless device 14-3 to the wireless device 14-2. The wireless device 14-2 utilizes this information to perform a desired action with respect to D2D communication between the wireless devices 14-2 and 14-3.

More specifically, first, the wireless device 14-3 obtains the number of receiver antennas and/or the number of SDM layers of the receiver of the wireless device 14-3 as discussed above (step 1600). Optionally, the wireless device 14-2 sends a request to the wireless device 14-3 for the number of receiver antennas and/or the number of SDM layers of the receiver of the wireless device 14-3 (step 1602). Next, the wireless device 14-3 unicasts the number of receiver antennas and/or the number of SDM layers of the receiver of the wireless device 14-3 to the wireless device 14-2 (step 1604). The wireless device 14-3 unicasts the number of receiver antennas and/or the number of SDM layers to the wireless device 14-2 using any suitable unicast mechanism. The unicast may be made during establishment of a D2D connection between the wireless devices 14-2 and 14-3 or after (e.g., in response to) establishment of a D2D connection between the wireless devices 14-2 and 14-3. Upon receiving the unicast, the wireless device 14-2 utilizes the number of receiver antennas and/or the number of SDM layers of the receiver of the wireless device 14-3 to perform a desired action (step 1606). As discussed above, the desired action may be, for example, determining a precoding matrix for a D2D transmission(s) from the wireless device 14-2 to the wireless device 14-3, determining whether to apply one or more MIMO techniques for a D2D transmission(s) from the wireless device 14-2 to the wireless device 14-3, or configuring one or more MIMO techniques for a D2D transmission(s) from the wireless device 14-2 to the wireless device 14-3.

FIG. 18 is a flow diagram that illustrates explicit signaling of the number of receiver antennas and/or the number of SDM layers of one of the wireless devices 14 to another one of the wireless devices 14 using a unicast mechanism according to another embodiment of the present disclosure. This embodiment is referred to herein as a network-assisted embodiment. First, the wireless device 14-3 obtains the number of receiver antennas and/or the number of SDM layers of the receiver of the wireless device 14-3 as discussed above (step 1700). Next, the wireless device 14-3 sends the number of receiver antennas and/or the number of SDM layers of the receiver of the wireless device 14-3 to the base station 12-1 (step 1702). The wireless device 14-3 sends the number of receiver antennas and/or the number of SDM layers of the receiver of the wireless device 14-3 to the base station 12-1 using any suitable mechanism (e.g., RRC signaling).

Optionally, the wireless device 14-2 sends a request to the base station 12-1 for the number of receiver antennas and/or the number of SDM layers of the receiver of the wireless device 14-3 (step 1704). The base station 12-1 then unicasts the number of receiver antennas and/or the number of SDM layers of the receiver of the wireless device 14-3 (step 1706). In one particular embodiment, the cellular communications network 10 is a 3GPP LTE cellular communications network, and the base station 12-1 unicasts the number of receiver antennas and/or the number of SDM layers of the receiver of the wireless device 14-3 to the wireless device 14-2 using RRC signaling (e.g., using a RRC Connection Confirm message, a RRC Reconfiguration Request, or a new RRC message). Upon receiving the unicast, the wireless device 14-2 utilizes the number of receiver antennas and/or the number of SDM layers of the receiver of the wireless device 14-3 to perform a desired action (step 1708). As discussed above, the desired action may be, for example, determining a precoding matrix for a D2D transmission(s) from the wireless device 14-2 to the wireless device 14-3, determining whether to apply one or more MIMO techniques for a D2D transmission(s) from the wireless device 14-2 to the wireless device 14-3, or configuring one or more MIMO techniques for a D2D transmission(s) from the wireless device 14-2 to the wireless device 14-3.

FIG. 19 illustrates a process for determining or using a precoding matrix for D2D transmission(s) from the wireless device 14-2 to the wireless device 14-3 according to one embodiment of the present disclosure. First, the wireless device 14-2 determines one or more precoding matrices for one or more D2D transmissions from the wireless device 14-2 to the wireless device 14-3 based on the number of receiver antennas and/or the number of SDM layers of the receiver of the wireless device 14-3 (step 1800). Typically, a precoding matrix for a transmission from the wireless device 14-2 to the wireless device 14-3 includes a number of rows that correspond to the number of receiver antennas of the receiver of the wireless device 14-3 and a number of columns that correspond to the number of transmitter antennas of a transmitter of the wireless device 14-2. Using the number of receiver antennas of the wireless device 14-3 and the number of transmitter antennas of the wireless device 14-2, the wireless device 14-2 can select or otherwise determine a precoding matrix of the appropriate size. Further, in some embodiments, the number of SDM layers of the receiver of the base station 12 may also be used to select or otherwise determine the one or more precoding matrices for the uplink transmission(s). Once the one or more precoding matrices are determined, the wireless device 14-2 precodes the one or more D2D transmissions using the corresponding one or more precoding matrices (step 1802) and transmits the precoded D2D transmission(s) to the wireless device 14-3 (step 1804).

FIG. 20 illustrates a process for determining whether to apply one or more MIMO techniques and configuring the one or more MIMO techniques according to one embodiment of the present disclosure. First, the wireless device 14-2 determines whether to apply one or more MIMO techniques to a D2D transmission(s) from the wireless device 14-2 to the wireless device 14-3 based on the number of receiver antennas and/or the number of SDM layers of the receiver of the wireless device 14-3 (step 1900). If a determination is made to not apply the MIMO technique(s), the process proceeds to step 1904. If a determination is made to apply the MIMO technique(s), the wireless device 14-2 then configures the MIMO technique(s) (step 1902). In this embodiment, the MIMO technique(s) are configured based on the number of receiver antennas and/or the number of SDM layers of the receiver of the wireless device 14-3. More specifically, as one example, the wireless device 14-2 determines that one or more MIMO techniques are desired to reduce interference caused to a base station 12 closest to the wireless device 14-2 as a result of D2D transmissions from the wireless devices 14-2 and 14-3. More specifically, if the wireless device 14-2 transmits to the wireless device 14-3 using an uplink resource(s) of the cell 16-1 (FIG. 1), then transmissions from the wireless device 14-2 to the wireless device 14-3 using the uplink resource(s) will cause interface at the base station 12-1. The wireless device 14-2 may then configure one or more MIMO techniques to reduce the amount of interference caused to the base station 12-1. For instance, the wireless device 14-2 may configure a beam-forming MIMO technique to create a null in the direction of the base station 12-1. Beam-forming can be provided by precoding the transmission(s) of the wireless device 14-2 using appropriate precoding matrices. In order to form these precoding matrices, a size of the precoding matrices must be defined. Typically, the number of columns of the precoding matrix corresponds to the number of transmitter antennas and the number of rows corresponds to the number of receiver antennas. As such, the wireless device 14-2 can utilize the number of receiver antennas of the wireless device 14-3 to select or otherwise determine the appropriate precoding matrices to form nulls in the direction of the closest base station, which again for this example is the base station 12-1.

As another example, the wireless device 14-2 may determine whether spatial multiplexing is desired for transmissions from the wireless device 14-2 to the wireless device 14-3. If so, the spatial multiplexing can be configured based on the number of receiver antennas and/or the number of SDM layers of the receiver of the wireless device 14-3. For instance, spatial multiplexing may be utilized to spatially separate D2D transmissions from the wireless device 14-2 to the wireless device 14-3 from D2D transmissions between a different pair of wireless devices 14 or transmissions between another wireless device 14 and a nearby base station 12 (e.g., the base station 12-1) using the same physical resources. Lastly, whether proceeding from step 1900 or 1902, the wireless device 14-2 transmits D2D transmissions to the wireless device 14-3 (step 1904). If the MIMO technique(s) are to be applied and are configured, the D2D transmissions are transmitted using the MIMO technique(s). Otherwise, the D2D transmissions are transmitted without using the MIMO technique(s).

Before proceeding, it should be noted that FIGS. 19 and 20 are only some examples of desired actions that may be performed by the wireless device 14-2 based on the number of receiver antennas and, in some embodiments, the number of SDM layers of the receiver of the wireless device 14-3. Other desired actions may additionally or alternatively be performed. For example, blind null space learning is a MIMO technique that requires that the number of transmitter antennas may be higher than the number of receiver antennas. As such, the wireless device 14-2 may determine whether to apply blind null space learning based, at least in part, on the number of receiver antennas of the wireless device 14-3 as compared to the number of transmitter antennas of the wireless device 14-3 (which is known). The wireless device 14 may further use the number of receiver antennas to configure blind null space learning.

As another example, the wireless device 14-2 may utilize the number of receiver antennas and/or the number of SDM layers for each of a number of potential wireless devices 14 for a D2D connection to select a desired wireless device 14 for the D2D connection. More specifically, in this example, the wireless device 14-2 obtains the number of receiver antennas and/or the number of SDM layers of a number of wireless devices 14 within a D2D range of the wireless device 14-2. The wireless devices 14 within the D2D range of the wireless device 14-2 are potential wireless devices 14 for the D2D connection. Notably, the wireless device 14-3 is one of the potential wireless devices 14 for the D2D connection. The wireless device 14-2 then selects a desired wireless device 14 for the D2D connection, which in this example is the wireless device 14-3, based on the number of receiver antennas and/or the number of SDM layers of each of the potential wireless devices 14 for the D2D connection. Thus, for example, if the wireless device 14-3 and another wireless device 14 are the same or approximately the same radio distance from the wireless device 14-3 but the wireless device 14-3 has four receiver antennas whereas the other wireless device 14 has only two receiver antennas, then the wireless device 14-2 selects the wireless device 14-3 for the D2D connection.

In the embodiments above, one of the wireless devices 14 receives the number of receiver antennas and/or the number of SDM layers of the receiver of each of one or more other nodes in the cellular communications network 10. FIG. 21 is a flow diagram that illustrates explicit signaling of the number of receiver antennas and/or the number of SDM layers of the receiver of one of the wireless devices 14 to one of the base stations 12 (e.g., the serving base station 12 of the wireless device 14). The base station 12 then utilizes the number of receiver antennas and/or the number of SDM layers of the wireless device 14 to perform a desired action.

More specifically, the wireless device 14 first obtains the number of receiver antennas and/or the number of SDM layers of the receiver of the wireless device 14 as discussed above (step 2000). Next, the wireless device 14 unicasts the number of receiver antennas and/or the number of SDM layers of the receiver of the wireless device 14 to the base station 12 (step 2002). Any suitable unicast mechanism may be used. For example, RRC signaling may be used to explicitly signal the number of receiver antennas and/or the number of SDM layers of the receiver of the wireless device 14 to the base station 12. The base station 12 then performs a desired action based on the number of receiver antennas and/or the number of SDM layers of the receiver of the wireless device 14 (step 2004). In one embodiment, the desired action performed by the base station 12 is determining a precoding matrix for a downlink transmission(s) to the wireless device 14 based on the number of receiver antennas and/or the number of SDM layers of the receiver of the wireless device 14. In yet another embodiment, the desired action performed by the base station 12 is determining whether to apply one or more MIMO techniques (e.g., diversity, beam forming, and/or spatial division multiplexing) for a downlink transmission(s) from the base station 12 to the wireless device 14 and/or configuring the one or more MIMO techniques for the downlink transmission(s) from the base station 12 to the wireless device 14. Note that these examples of the desired action are examples only and are not intended to limit the scope of the present disclosure.

It should be noted that in conventional 3GPP LTE cellular communications networks, wireless devices transmit the number of transmit antennas and their transmit modes to the base stations by using IE Antenna Info. In addition, the base stations are aware of the wireless device category of each wireless device via corresponding RRC wireless device Capability Information messages. A maximum number of receiver SDM layers is defined for each wireless device category (i.e., wireless device Category 1 has maximum of 1 SDM layers in the downlink, Category 2 has a maximum of 2 SDM layers in downlink, Category 3 has a maximum of 2 SDM layers in the downlink, etc.), as specified in 3GPP TS 36.306. In many cases, a base station could infer the number of receiver antennas for a wireless device based on the maximum number of SDM layers in the downlink for the wireless device. However, in the conventional LTE cellular communications networks, the wireless devices do not explicitly signal their number of receiver antennas to the base stations. Thus, using the conventional information known to the base stations, the base stations may infer, or guess, at the number of receiver antennas of the wireless devices, but the base stations do not in fact know the number of receiver antennas of the wireless devices. As such, explicit signaling of the number of receiver antennas from the wireless devices to the base stations as described above with respect to FIG. 21 would be beneficial.

FIG. 22 is a block diagram of one of the wireless devices 14 according to one embodiment of the present disclosure. As illustrated, the wireless device 14 includes a transceiver subsystem 24 and a processing subsystem 26. The transceiver subsystem 24 generally includes analog and, in some embodiments, digital components for sending and receiving data to and from the base stations 12 and, in some embodiments, other wireless devices 14. In particular embodiments, the transceiver subsystem 24 may represent or include one or more Radio Frequency (RF) transceivers, or separate RF transmitter(s) and receiver(s), capable of transmitting suitable information wirelessly to and receiving suitable information from other network components or nodes. From a wireless communications protocol view, the transceiver subsystem 24 implements at least part of Layer 1 (i.e., the Physical or “PHY” Layer).

The processing subsystem 26 generally implements any remaining portion of Layer 1 as well as functions for higher layers in the wireless communications protocol (e.g., Layer 2 (data link layer), Layer 3 (network layer), etc.). In particular embodiments, the processing subsystem 26 may comprise, for example, one or several general-purpose or special-purpose microprocessors or other microcontrollers programmed with suitable software and/or firmware to carry out some or all of the functionality of the mobile terminal 14 described herein. In addition or alternatively, the processing subsystem 26 may comprise various digital hardware blocks (e.g., one or more Application Specific Integrated Circuits (ASICs), one or more off-the-shelf digital and analog hardware components, or a combination thereof) configured to carry out some or all of the functionality of the wireless device 14 described herein. Additionally, in particular embodiments, the above described functionality of mobile terminal 14 may be implemented, in whole or in part, by the processing subsystem 26 executing software or other instructions stored on a non-transitory computer-readable medium, such as Random Access Memory (RAM), Read Only Memory (ROM), a magnetic storage device, an optical storage device, or any other suitable type of data storage components. Of course, the detailed operation for each of the functional protocol layers, and thus the transceiver subsystem 24 and the processing subsystem 26, will vary depending on both the particular implementation as well as the standard or standards supported by the mobile terminal 14.

FIG. 23 is an enlarged block diagram of the wireless device 14 of FIG. 22 according to one embodiment of the present disclosure. As illustrated, the processing subsystem 26 includes a processor 27 that is configured to process a symbol vector (S) including a number (r) of symbol streams (S-1 through S-r) provided by SDM layers 28-1 through 28-r for transmission by the wireless device 14 to another network node (i.e., another wireless device 14 or one of the base stations 12). More particularly, the processing subsystem 26 defines a precoder 30 configured to precode the symbol streams (S-1 through S-r) for the SDM layers 28-1 through 28-r based on a precoding matrix (W_{NtXR}) to provide a number (Nᵢₜ) of antenna signals. The number (Nₜ) corresponds to the number of transmit antennas of the wireless device 14, which are shown as antenna elements 34-1 through 34-Nₜ. The antenna signals output by the precoder 30 are processed by Inverse Fast Fourier Transform (IFFT) elements 32-1 through 32-Nₜ and resulting transformed signals are then transmitted by a transmitter 36 of the transceiver subsystem 24. More specifically, the transformed signals are upconverted and amplified by corresponding transmitter elements 38-1 through 38-Nₜ of the transmitter 36 and the resulting RF signals are passed to the corresponding antenna elements 34-1 through 34-Nₜ in an antenna array 40 of the transceiver subsystem 24. The processor 27 may select the precoding matrix (W_{NtXR}) from a precoder codebook 42 stored in memory 44. As discussed above, in some embodiments, the processor 27 selects the precoding matrix (W_{NtXR}) based on the number of receiver antennas and/or the number of SDM layers of the receiver of another node (e.g., the serving base station 12 or another wireless device 14) in the cellular communications network 10.

The transceiver subsystem 24 also includes a receiver 46. In this example, the number of antennas utilized by the receiver 46 can be any number of the antenna elements 34-1 through 34-Nₜ in the antenna array 40. So, the number of receiver antennas can be, in this example, any number between 1 and Nₜ. It should be noted, however, that the number of receiver antennas may alternatively be greater than Nₜ. The receiver 46 outputs a number of received signals, which in this example include a separate receive signal for each of the receiver antennas. If SDM is utilized for the transmission to the wireless device 14, the processing subsystem 26 processes the received signals to provide a separate symbol stream for each SDM layer for the receiver 46. The number of SDM layers for the receiver 46 may be different than the number of SDM layers for the transmitter 36.

FIG. 24 is a block diagram of one of the base stations 12 according to one embodiment of the present disclosure. As illustrated, the base station 12 includes a communication interface 48, a transceiver subsystem 50, and a processing subsystem 52. The communication interface 48 enables communication between the base station 12 and the core network 18 (FIG. 1) (e.g., via S1 interfaces) and communication with other base stations 12 (e.g., via X2 interfaces). The transceiver subsystem 50 includes a transmitter, a receiver, and an antenna array in much the same manner as described above with respect to the wireless device 14. The transmitter and the receiver each utilize one or more antenna elements (or simply antennas) in the antenna array and, for MIMO operation, utilize multiple antennas. The transceiver subsystem 50 generally includes analog and, in some embodiments, digital components for sending and receiving data to and from wireless devices 14 within the corresponding cell 16. In particular embodiments, the transceiver subsystem 50 may represent or include one or more RF transceiver(s), or separate RF transmitter(s) and receiver(s), capable of transmitting suitable information wirelessly to and receiving suitable information from other network components or nodes. From a wireless communications protocol view, the transceiver subsystem 50 implements at least part of Layer 1 (i.e., the Physical or “PHY” Layer).

The processing subsystem 52 generally implements any remaining portion of Layer 1 not implemented in the transceiver subsystem 50 as well as functions for higher layers in the wireless communications protocol (e.g., Layer 2 (data link layer), Layer 3 (network layer), etc.). In particular embodiments, the processing subsystem 52 may comprise, for example, one or several general-purpose or special-purpose microprocessors or other microcontrollers programmed with suitable software and/or firmware to carry out some or all of the functionality of the base station 12 described herein. In addition or alternatively, the processing subsystem 52 may comprise various digital hardware blocks (e.g., one or more ASICs, one or more off-the-shelf digital and analog hardware components, or a combination thereof) configured to carry out some or all of the functionality of the base station 12 described herein. Additionally, in particular embodiments, the above described functionality of base station 12 may be implemented, in whole or in part, by the processing subsystem 52 executing software or other instructions stored on a non-transitory computer-readable medium, such as RAM, ROM, a magnetic storage device, an optical storage device, or any other suitable type of data storage components.

In a manner similar to that described above with respect to the processing subsystem 26 of the wireless device 14, the processing subsystem 52 of the base station 12 preferably defines one or more SDM layers for the transmitter of the transceiver subsystem 50 as well as one or more SDM layers for the receiver of the transceiver subsystem 50. The number of SDM layers for the transmitter and the receiver may be configured as desired. As discussed above, in some embodiments, the processing subsystem 52 operates to explicitly signal the number of receiver antennas of the receiver of the base station 12 and/or the number of SDM layers utilized for the receiver of the base station 12 to the wireless devices 14. In other embodiments, the processing subsystem 52 receives the number of receiver antennas and/or the number of SDM layers of the wireless device 14 and performs a desired action based thereon (e.g., determine precoding matrix for transmission(s) to the wireless device 14, determine whether to apply MIMO technique(s) for transmission(s) to the wireless device 14, or configuring MIMO technique(s) for transmission(s) to the wireless device 14).

The following acronyms are used throughout this disclosure.
3GPP 3^{rd} Generation Partnership Program
ASIC Application Specific Integrated Circuit
BS Base Station
D2D Device-to-Device
dB Decibel
dBm Decibel-milliwatt
DL-PDCCH Downlink Physical Downlink Control Channel
DL-SCH Downlink Shared Channel
eNB eNodeB
GPRS General Packet Radio Service
GSM Global System for Mobile Communications
HSPA High Speed Packet Access
IE Information Element
IFFT Inverse Fast Fourier Transform
LTE Long Term Evolution
M2M Machine-to-Machine
MIMO Multiple Input Multiple Output
MME Mobility Management Entity
RAM Random Access Memory
RAN Radio Access Network
RF Radio Frequency
ROM Read Only Memory
RRC Radio Resource Control
RSRP Reference Signal Receive Power
RX Receiver
SDM Spatial Division Multiplexing
S-GW Serving Gateway
SIB System Information Block
TS Technical Specification
UE User Equipment
UL Uplink
WD Wireless Device

Those skilled in the art will recognize improvements and modifications to the preferred embodiments of the present disclosure. All such improvements and modifications are considered within the scope of the concepts disclosed herein and the claims that follow.

What is claimed is:

1. A system comprising:
a first node in a cellular communications network; and
a second node in the cellular communications network configured to obtain a number of receiver antennas of the first node and utilize the number of receiver antennas of the first node to perform a desired action.

2. A node in a cellular communications network, comprising:
a transceiver subsystem; and
a processing subsystem that is associated with the transceiver subsystem and is configured to send a number of receiver antennas in the transceiver subsystem to a second node in the cellular communications network.

3. The node of claim 2 wherein the processing subsystem is further configured to send a number of Spatial Division Multiplexing layers utilized by a receiver of the transceiver subsystem to the second node.

4. The node of claim 2 wherein the node is a base station and the second node is a wireless device, and the processing subsystem is configured to send the number of receiver antennas in the transceiver subsystem of the base station to the wireless device.

5. The node of claim 4 wherein, in order to send the number of receiver antennas in the transceiver subsystem of the base station to the wireless device, the processing subsystem is configured to broadcast the number of receiver antennas via the transceiver subsystem.

6. The node of claim 5 wherein the cellular communications network is a 3GPP Long Term Evolution cellular communications network, and the processing subsystem is further configured to broadcast the number of receiver antennas in a System Information Block in a shared downlink channel of the base station.

7. The node of claim 4 wherein, in order to send the number of receiver antennas in the transceiver subsystem of the base station to the wireless device, the processing subsystem is configured to unicast the number of receiver antennas to the wireless device via the transceiver subsystem.

8. The node of claim 7 wherein the cellular communications network is a 3GPP Long Term Evolution cellular communications network, and the processing subsystem is further configured to unicast the number of receiver antennas to the wireless device via Radio Resource Control signaling.

9. The node of claim 2 wherein the node is a base station and the second node is a wireless device, and the processing subsystem is configured to send the number of receiver antennas in the transceiver subsystem of the base station and a number of receiver antennas of each of one or more additional base stations to the wireless device.

10. The node of claim 9 wherein the one or more additional base stations are one or more neighboring base stations of the base station.

11. The node of claim 9 further comprising:
a communication interface configured to communicatively couple the base station to the one or more additional base stations;
wherein, for each additional base station of the one or more additional base stations, the processing subsystem is further configured to receive the number of receiver antennas of the additional base station via the communication interface.

12. The node of claim 9 wherein, in order to send the number of receiver antennas in the transceiver subsystem of the base station and the number of receiver antennas of each of the one or more additional base stations to the wireless device, the processing subsystem is configured to broadcast the number of receiver antennas in the transceiver subsystem of the base station and the number of receiver antennas of each of the one or more additional base stations via the transceiver subsystem.

13. The node of claim 12 wherein the cellular communications network is a 3GPP Long Term Evolution cellular communications network, and the processing subsystem is further configured to broadcast the number of receiver antennas in the transceiver subsystem of the base station and the number of receiver antennas of each of the one or more additional base stations in one or more System Information Blocks in a shared downlink channel of the base station.

14. The node of claim 9 wherein, in order to send the number of receiver antennas in the transceiver subsystem of the base station and the number of receiver antennas of each of the one or more additional base stations to the wireless device, the processing subsystem is configured to unicast the number of receiver antennas in the transceiver subsystem of the base station and the number of receiver antennas of each of the one or more additional base stations to the wireless device via the transceiver subsystem.

15. The node of claim 14 wherein the cellular communications network is a 3GPP Long Term Evolution cellular communications network, and the processing subsystem is further configured to unicast the number of receiver antennas in the transceiver subsystem of the base station and the number of receiver antennas of each of the one or more additional base stations to the wireless device via Radio Resource Control signaling.

16. The node of claim 2 wherein the node is a first wireless device and the second node is a second wireless device, and the processing subsystem is configured to send the number of receiver antennas in the transceiver subsystem of the first wireless device to the second wireless device.

17. The node of claim 16 wherein, in order to send the number of receiver antennas in the transceiver subsystem of the first wireless device to the second wireless device, the processing subsystem is configured to broadcast the number of receiver antennas via the transceiver subsystem.

18. The node of claim 16 wherein, in order to send the number of receiver antennas in the transceiver subsystem of the first wireless device to the second wireless device, the processing subsystem is configured to unicast the number of receiver antennas to the second wireless device via the transceiver subsystem.

19. The node of claim 2 wherein the node is a wireless device and the second node is a base station, and the processing subsystem is configured to send the number of receiver antennas in the transceiver subsystem of the wireless device to the base station.

20. A method of operation of a node in a cellular communications network, comprising:
obtaining a number of receiver antennas of the node; and
sending the number of receiver antennas of the node to a second node in the cellular communications network.

21. A base station in a cellular communications network comprising:
a transceiver subsystem; and
a processing subsystem associated with the transceiver subsystem configured to:
obtain a number of receiver antennas of a first wireless device in the cellular communications network; and
send the number of receiver antennas of the first wireless device to a second wireless device in the cellular communications network via the transceiver subsystem.

22. The base station of claim 21 wherein, in order to send the number of receiver antennas of the first wireless device to the second wireless device, the processing subsystem is further configured to broadcast the number of receiver antennas of the first wireless device.

23. The base station of claim 21 wherein, in order to send the number of receiver antennas of the first wireless device to the second wireless device, the processing subsystem is further configured to unicast the number of receiver antennas of the first wireless device to the second wireless device.

24. A node in a cellular communications network, comprising:
a transceiver subsystem; and
a processing subsystem associated with the transceiver subsystem configured to:
obtain a number of receiver antennas of a second node in the cellular communications network via the transceiver subsystem; and
utilize the number of receiver antennas of the second node to perform a desired action.

25. The node of claim 24 wherein the processing subsystem is further configured to:
obtain a number of Spatial Division Multiplexing layers of the second node via the transceiver subsystem; and
utilize the number of receiver antennas of the second node and the number of Spatial Division Multiplexing layers of the second node to perform the desired action.

26. The node of claim 24 wherein the node is a wireless device, the second node is a base station, and the desired action comprises making a handover decision.

27. The node of claim 24 wherein the desired action comprises determining one or more precoding matrices for one or more transmissions from the node to the second node.

28. The node of claim 24 wherein the desired action comprises determining whether to apply one or more Multiple Input Multiple Output techniques for transmissions from the node.

29. The node of claim 24 wherein the desired action comprises configuring one or more Multiple Input Multiple Output techniques for transmissions from the node based on the number of receiver antennas of the second node.

30. The node of claim 24 wherein, in order to obtain the number of receiver antennas of the second node, the processing subsystem is further configured to receive the number of receiver antennas of the second node via a broadcast from the second node.

31. The node of claim 24 wherein, in order to obtain the number of receiver antennas of the second node, the processing subsystem is further configured to receive the number of receiver antennas of the second node via a unicast from the second node.

32. The node of claim 24 wherein the node is a first wireless device in the cellular communications network, the second node is a second wireless device in the cellular communications network, and, in order to obtain the number of receiver antennas of the second node, the processing subsystem is further configured to receive the number of receiver antennas of the second wireless device via a broadcast from a base station in the cellular communications network.

33. The node of claim 24 wherein the node is a first wireless device in the cellular communications network, the second node is a second wireless device in the cellular communications network, and, in order to obtain the number of receiver antennas of the second wireless device, the processing subsystem is further configured to receive the number of receiver antennas of the second wireless device via a unicast from a base station in the cellular communications network.

34. The node of claim 24 wherein the node is a first wireless device and the second node is one of a plurality of potential wireless devices for a direct device-to-device connection with the first wireless device, and the desired action is selecting one of the plurality of potential wireless devices as a desired wireless device for the direct device-to-device connection based on the number of receiver antennas of the second node and a number of receiver antennas of each other wireless device in the plurality of potential wireless devices for the direct device-to-device connection.

35. A method of operation of a node in a cellular communications network, comprising:
obtaining a number of receiver antennas of a second node in the cellular communications network; and
utilizing the number of receiver antennas of the second node to performed a desired action.

36. The method of claim 35 wherein the node is a first wireless device in the cellular communications network, the second node is a second wireless device in the cellular communications network, and the desired action is selecting a desired wireless device for a direct device-to-device connection from a plurality of wireless devices comprising the second wireless device based on a number of receiver antennas for each of the plurality of wireless devices.
